(19) United States
(12) Patent Application Publication
(10) Pub. No.: US 2002/0021680 A1
(43) Pub. Date: Feb. 21, 2002

(54) Method of operating a mobile telecommunications network to provide route optimistaion and quality of service

(76) Inventor: Xiaobao X. Chen, Swindon (GB)

Correspondence Address: Docket Administrator (Room 3J-219), Lucent Technologies Inc., 101 Crawfords Corner road, Holmdel, NJ, 07733-3030, US

(21) Appl. No.: 09/918,175

(22) Filed: Jul. 30, 2001

(30) Foreign Application Priority Data
Aug. 21, 2000 (GB) 0020582.3

(51) Int. Cl. H04Q 7/00

(52) U.S. Cl. 370/331; 370/352

(57) ABSTRACT

In a 3G telecom network, when a mobile wanders in a foreign network and a home agent (26) is allocated a Care of Address for the mobile, the home agent (26) also changes packet headers so that the destination address is the Care of Address, and there is a mobile node identifier field (50); the home agent maintains a mapping table of mobile nodes and mobile node identifiers. Route optimization is therefore provided. Quality of Service can be provided; when the mobile node sends a PATH message and a RSVP proxy server is built into the mobile node, the server changes the packet header source address to the mobile node Care of Address, to prevent misrouting of the RESV message to the home network.

### CROSS-REFERENCE TO RELATED APPLICATION

This application claims priority of Great Britain Patent Application No. 0020582.3, which was filed on Aug. 21, 2000.

### BACKGROUND OF THE INVENTION

1. Field of the Invention

This invention relates to an improved method of operating a mobile telecommunications network, especially a third generation network, to provide route optimization and quality of service (QoS).

2. Description of Related Art

In third generation telecommunications networks such as GPRS (General Packet Radio Service) and EDGE (Enhanced Data-rate for GSM Evolution), when a mobile terminal moves into a foreign network, network connectivity is optionally maintained by the use of Mobile Internet Protocol (Mobile IP). In the home network, a Home Agent (HA) is set up which maintains the location information of the mobile by use of Binding Updates, i.e., registration of information sent to the HA by the mobile node.

Mobile IP has two working modes. The first is illustrated in FIG. 1; a mobile terminal is currently attached as a Mobile Node (MN) 14 in a network different from its home network. The MN 14 is communicating with a Correspondent Node (CN) 12. A Home Agent 16 is set up in the home network by the CN 12, and a Foreign Agent (FA) 18 is set up in the foreign network. The FA 18 allocates a unique IP address for the visiting mobile, a Care of Address (COA) and this address is sent to the HA 16 in a Binding Update.

Packets for the mobile are encapsulated by the HA 16 and tunneled along tunnel 20 to the FA 18 for transmission to MN 14. In such encapsulation, an extra IP header is added to each packet, including the COA of the MN 14. This is known as FA-COA working mode.

In the second working mode (not illustrated) there is no FA, the MN 14 is allocated a unique COA and encapsulated packets are tunneled by HA 16 directly to MN 14; this is known as Collocated Care of Address mode of working (CO-COA).

In both FA-COA and CO-COA modes of working, the encapsulation generates extra headers and possibly only small payloads can be used, which results in inefficient transmission and inefficient use of expensive system and network resources, such as radio links. Further, encapsulation hides the flow identification, and the differentiation of classes of services is thus also disabled, so that Quality of Service (QoS) provision mechanisms, such as RSVP (Resource reSerVation Protocol) Int Serve, must be changed.

The disadvantages of encapsulation can be avoided by the use of Non Encapsulation Mobile IP technique, as set out in the applicant's co-pending patent application number 99301437.2 “Non-encapsulation Mobile IP” filed on Feb. 26, 1999. In this technique, the current COA of the mobile node is used as the destination address, and the original source address, i.e., the CN address, is maintained. For FA-COA working, this deletes a header of length at least 20 bytes and introduces a header of only 2 bytes; for CO-COA mode of working no header is introduced. However a disadvantage is that any firewall or egress filtering in the home network may reject such packets, because they have a source address different from the home network address.

### SUMMARY OF THE INVENTION

It is an object of the invention to provide a method of packet addressing which overcomes the disadvantages set out above, and allows QoS to be provided.

In both the conventional encapsulation method and the two non-encapsulation techniques, the use of a home agent for redirecting packets to the current Care of Address together with the CN and MN forms so-called “triangle routing”. This arrangement allows transparent inter-operation between the CN and the MN but forces all packets to be routed through the HA. One result of this is that packets may be routed along paths which are significantly longer than optimal, which can introduce delay into delivery, and also puts an unnecessary traffic load on the networks and routers involved. The technique of route optimization is known in Mobile IP when encapsulation techniques are used, but with encapsulation, transmission of extra headers leads to lower transmission efficiency and failure of QoS differentiation.

It is a further object of the invention to provide an improved method of route optimization which avoids the disadvantage of re-directing via a HA.

According to the invention, a method of operating a third generation mobile telecommunications system, in which packets are addressed to a mobile terminal which has a correspondent node and which is currently in a foreign network, comprising the steps of setting up a home agent in the home network and allocating a Care of Address in the foreign network for the mobile terminal, characterized by the further steps of the home agent changing the packet header so that the destination address is the Care of Address, and providing a mobile node identifier, whereby route optimization is provided.

### BRIEF DESCRIPTION OF THE DRAWINGS

In the accompanying drawings, FIG. 1 illustrates the prior art. FIG. 2 illustrates the problem to be solved; and FIG. 3 illustrates a prior art packet format using encapsulation technique.

The invention will be described by way of example only with reference to FIGS. 4 and 5 in which:

FIG. 4 illustrates a packet header format according to the invention;

FIG. 5a illustrates message exchange for a RSVP session originating from a CN; and

FIG. 5b illustrates a RSVP session originated in a mobile node.

### DETAILED DESCRIPTION

In FIG. 2, a mobile which is temporarily in a foreign network is shown as MN 28, which has a FA 30. The CN 24 of the mobile has set up a HA 26.

Reference to FIGS. 1 and 2 illustrates the problem of routing all packets via HA 16 or 26—routes may be long and will introduce delay.

FIG. 3 illustrates a packet format in which an original IP packet complete with its header is encapsulated in a packet having as the source address 34, the CN 12 (see FIG. 1) and as the destination address 36 the CoA of MN 14. The packet also contains other fields 38 and the payload 32 is the complete original packet.

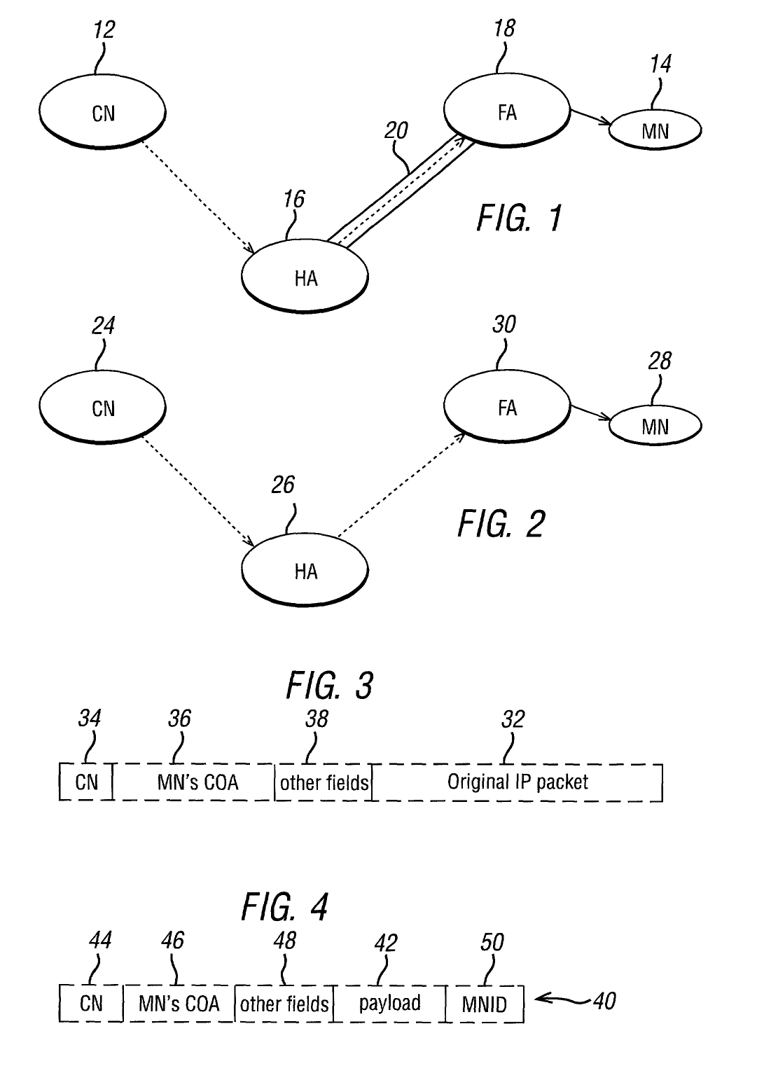

FIG. 4 shows the packet format 40 according to the invention. The source and destination addresses 44, 46 and the other fields 48 are unchanged, but the payload 42 now contains only the payload of the original packet, which gives a saving in length, but the header is lost. The packet now also contains the new field 50, the MNID, which is an identifier code for MN 28, and is only two bytes long.

The MNID field 50 is generated by FA 30, which keeps a mapping table of MNIDs and MNs. FA 30 also sends to the HA 26 the identifier for the MN 28 with which it will need to communicate to supply the mobile; conventionally the CN 24 will solicit the HA 16 for this information.

When a packet is received by FA 30, it uses the MNID information and the mapping table it holds to find for which of the several MNs it supports the packet is destined.

The MNID 50 is also used to recover the original destination address (the home address of MN 28) by replacing the MN's CoA with the MN's home IP address. When the system is operating in FACOA mode, the home IP address is found by the FA 30 looking in its mapping table of MNIDs and MNs. The FA 30 then strips the MNID field 50 from the packet, makes a correspondent adjustment of the other IP header fields, such as recalculation of the checksum, and then delivers it to the MN.

When the system is operating in COCOA mode, the MN has already received the packet; it recalculates the checksum, and delivers the packet to the higher layers of the system.

With the use of a packet in the format shown in FIG. 4, the disadvantages of routing all packets via HA 26 (FIG. 2) are overcome. The packets go directly to the FA 30 (FACOA working mode) or to MN 28 (COCOA working mode). Further, all necessary information for identifying the traffic flows from the correspondent node 24 to the current COA of the mobile node 28 remains unchanged. This allows a simple adaptation of QoS session to be applied to follow the movement of the mobile as it wanders; a QoS session such as RSVP can be set up directly between CN 24 and MN 28. The class of service differentiation for QoS provision between the CN and MN will still be effective regardless of a change in the MN's network attachment point. A QoS session can have either the CN or MN as the sender. Examples will be given using RSVP (Resource reSerVation Protocol) as an example.

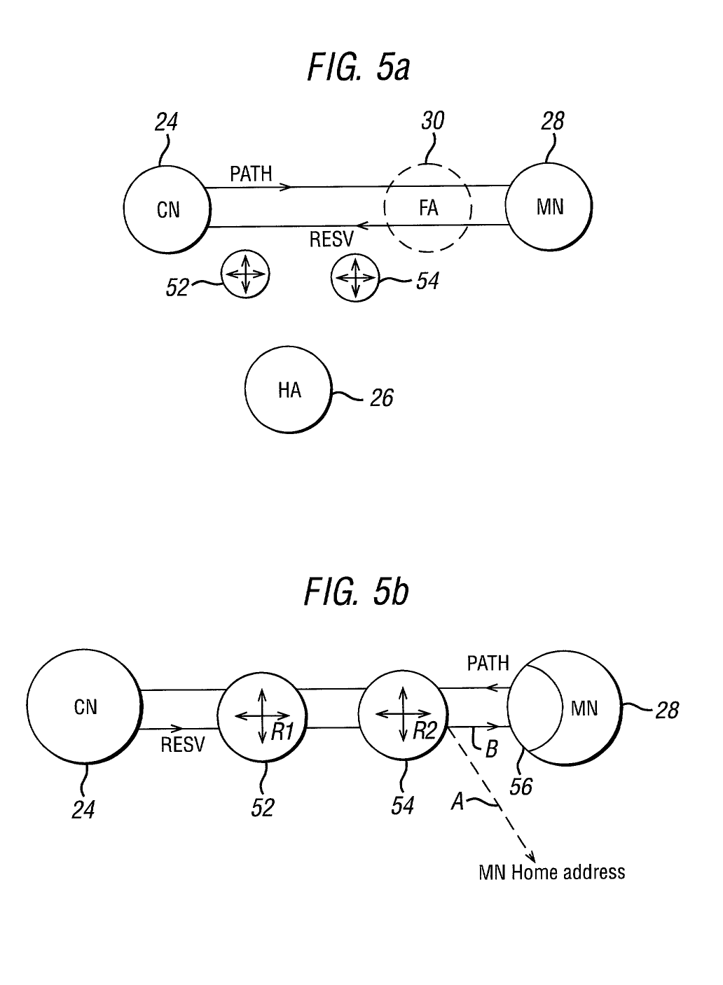

When the CN 24 is the sender and the MN 28 is the receiver, as shown in FIG. 5a, an RSVP proxy server or its equivalent in the corespondent network initiates a PATH message, with the source and destination addresses being:-

CN:PATH msg: Scr addr:

Dest addr: MN's COA

When the PATH message is received, either the proxy server or its equivalent in the foreign network in the MN 28 (for COCOA mode of working) or FA 30 (for FACOA mode of working) prepares a RESV message, as follows:-

MN:RESV msg: Src addr: MN's COA

Dest addr: CN

Other flow identification information such as protocol ID as well as source/destination port numbers are added and the message is dispatched.

In FIG. 5a the FA 30 is shown dotted as it is not active in COCOA working mode.

The RESV message is routed hop-by-hop from the foreign network to the correspondent network following the same route as the PATH message but in the reverse direction. Two network switching elements or routers, 52, 54 on the routes are shown in FIG. 3a. The routers change the source and address headers appropriately for each hop. When the RSVP proxy server or its equivalent in the correspondent node receives the RESV message, a RESV confirmation message is sent out, if requested, to confirm the establishment of the whole RSVP session.

When the MN 28 is the sender and the CN 24 is the receiver of a PATH message, the format is:-

MN:PATH msg: Src addr: MN's home address

Dest addr: CN

CN: RESV msg: Src addr: CN

Dest addr: MN's home address

The message generation and exchanges are similar to those described when the CN is the sender. However the location of the proxy server in the foreign network can now affect the message route.

If the proxy server in the foreign network is a separate entity running on a different host machine from the mobile node 28, or even built into FA 30, it will bear an IP address which is local to the foreign network but different to the MN's home address. The previous hop (PHOP) of the first routing switch or router 54 from the foreign network to the correspondent network is recorded to be the proxy server. In these circumstances, the RESV message which originated from CN 24 is successfully routed back to the foreign network and received by the proxy server.

However, if the foreign proxy server is built into the MN 28, as shown at reference 56 in FIG. 5b, then the previous hop PHOP of the first routing switch 54 will be recorded as the MN 28 at its home address. When the RESV message reaches his first hop, it will use the MN's home address as the destination address, and the RESV message will eventually be routed to the mobile node home network instead of reaching the proxy server in the foreign network.

Considering the message addressing in more detail, when MN 28 generates a PATH message, it is sent end to end to the CN, but the network sends it via the routers such as 52, 54. The first leg from proxy 56 to router 54 is addressed as:

PATH state: previous hop: MN's home address

next hop: R1 (52)

from router 54 to router 52:

PATH state: previous hop: R2

next hop: CN (24)

When CN 24 returns a RESV message, the addressing is now hop-by-hop in the reverse direction to the PATH message, i.e.,:

RESV state: Src: CN

Dest: R1

from router 52 (R1) to router 54 (R2):

RESV state: Src R1

Dest R2

from router R2 (54):

RESV state: Src R2

Dest MN's home address

This is indicated by the dotted arrow A in FIG. 5b.

In these circumstances, the proxy server 56 in the foreign network is arranged to modify or regenerate a PATH message as follows:-

MN:PATH msg: Src addr: MN Care-of-Address

Dest addr: CN

CN: RESV msg: Src addr: CN

Dest addr: MN's Care-of-Address

The PATH and RESV messages pass between the MN 28 and CN 24 as before, but now the final hop of the RESV message is correctly directed towards the MN 28 in the foreign network, as indicated by the arrow B in FIG. 5b. A RESV confirmation message can also be correctly routed.

When data packets arrive at the CN 24, the MN's COA is replaced with the MN home address, which is available from the binding cache entry for the mobile node containing the mobile node home address.

Thus a QoS session can be set up successfully, no matter what the location of the proxy server.

I claim:

1. A method of operating a third generation mobile telecommunications system in which packets are addressed to a mobile node which is currently associated with a foreign network and which is communicating with a correspondent node, comprising the steps of:
setting up a home agent in the correspondent node;
allocating a Care of Address for the mobile terminal in the foreign network;
changing the packet header at the correspondent node so that the destination address is the Care of Address; and
providing a mobile node identifier whereby route optimization is provided.

2. A method according to claim 1 in which the Care of Address represents the current location of the mobile node.

3. A method according to claim 1 in which the Care of Address is the address of a foreign agent in the foreign network.

4. A method according to claim 3 in which the foreign agent stores a mapping table of mobile nodes and mobile node identifiers.

5. A method according to claim 4 in which, when a packet is received by the foreign agent, the foreign agent looks at its stored mapping table to locate the mobile node for which the packet is destined.

6. A method according to claim 1 comprising the further step of providing Quality of Service for the mobile in which an end-to-end Quality of Service enquiry message is sent from the correspondent node to the mobile node and a Quality of Service response message is returned hop-by-hop to the correspondent node.

7. A method according to claim 1 comprising the further step of providing Quality of Service for the mobile in which an end-to-end Quality of Service enquiry message is sent from the mobile node to the correspondent node, the mobile node having a built-in Quality of Service proxy server, and the proxy server changing the packet header source address to the MN Care of Address.

8. A method according to claim 6 in which the Quality of Service is Resource reSerVation Protocol.
